(19) United States
(12) Patent Application Publication
(10) Pub. No.: US 2009/0108154 A1
(43) Pub. Date: Apr. 30, 2009

(54) Window Mounting Bracket

(75) Inventor: Timothy W. Lucci, Amherst (CA)

Correspondence Address: YOUNG & BASILE, P.C., 3001 WEST BIG BEAVER ROAD, SUITE 624, TROY, MI, 48084, US

(73) Assignee: Atlantic All-weather Windows Ltd., Port Elgin (CA)

(21) Appl. No.: 12/255,883

(22) Filed: Oct. 22, 2008

Related U.S. Application Data
(60) Provisional application No. 60/982,462, filed on Oct. 25, 2007.

(51) Int. Cl. E06B 7/28

(52) U.S. Cl. 248/208

(57) ABSTRACT

Disclosed is an improved mounting bracket, for use with a window frame having a channel formed therein, the channel having a substantially T-shaped profile formed by a central slot defined in the window frame surface and a base disposed beneath the frame surface to which the slot extends and which is bisected thereby. The bracket is of the type having: a bracket body fastened, in use, to the frame of a structure adjacent a window opening to secure said window frame in said opening; and a pair of opposed lugs rigidly connected to the body and which are frictionally engaged in the base in use. The improvement comprises a further pair of opposed lugs rigidly connected to the body to provide a transport position for the bracket wherein the further pair of opposed lugs are rigidly, frictional engaged in the base and the body extends substantially lengthwise of the frame.

### CROSS-REFERENCE TO RELATED APPLICATION

This application claims benefit of the filing date of and right of priority of U.S. Provisional Patent Application Ser. No. 60/982,462 filed Oct. 25, 2007. The present invention relates to the field of construction.

### BACKGROUND OF THE INVENTION

In the construction industry, window frames are often formed out of plastic (typically vinyl) extrusions which are miter cut and secured together. Glass, etc. is secured inside the frames to form the completed windows. A common type of window frame has a channel formed therein, the channel having a substantially T-shaped profile formed by a central slot defined in the frame surface and a base disposed beneath the frame surface to which the slot extends and which is bisected thereby. To secure window frames of this type to a structure, metal brackets are known to be used. A known bracket has a bracket body and a pair of opposed lugs. The bracket body is fastened, in use, to the frame of a structure adjacent a window opening. The opposed lugs are rigidly connected to the bracket body and are frictionally engaged in the base of the channel in use. This frictional engagement serves as part of the connection between the window frame and mounting bracket in use, with a screw providing additional securement of the mounting bracket to the window frame. FIG. 6 shows a section of prior art extrusion of the type which is conventionally formed into window frames, with a mounting bracket according to the prior art engaged therewith in the manner in which it is engaged in use. So positioned, the pair of opposed lugs are frictionally engaged in the base 32, and a conventional screw passes through the mounting bracket into the extrusion, to provide greater stability. FIG. 9 further evidences the connection. For the purposes of shipping, the mounting brackets are normally secured by tape or the like to the window frames, since, in the operative position, they would protrude and be vulnerable to suffering and/or causing damage in transport.

### SUMMARY OF THE INVENTION

An improved mounting bracket forms one aspect of the invention. This improved bracket is for use with a window frame having a channel formed therein, the channel having a substantially T-shaped profile formed by a central slot defined in the frame surface and a base disposed beneath the frame surface to which the slot extends and which is bisected thereby. The improved bracket is of the type having a bracket body which is fastened, in use, to the frame of a structure adjacent a window opening; and a pair of opposed lugs rigidly connected to the bracket body and which are frictionally engaged in the base in use. The improvement comprises: a further pair of opposed lugs rigidly connected to the bracket body to provide a transport position for the improved mounting bracket wherein the further pair of opposed lugs are rigidly, frictionally engaged in the base and the bracket body extends substantially lengthwise of the frame.

A mounting bracket for use with a window frame forms another aspect of the invention. The window frame has a channel formed therein, the channel having a substantially T-shaped profile formed by a central slot defined in the window frame surface and a base disposed beneath the window frame surface to which the slot extends and which is bisected thereby. This mounting bracket comprises: a bracket body; a pair of opposed lugs rigidly connected to the bracket body; and a further pair of opposed lugs rigidly connected to the bracket body. The mounting bracket has a transport position wherein the further pair of opposed lugs are rigidly, frictionally engaged in the base and the bracket body extends substantially lengthwise of the window frame and further has an operative position wherein the pair of opposed lugs are rigidly, frictionally engaged in the base and the bracket body is fastened, in use, to the frame of a structure adjacent a window opening to secure said window frame in said window opening.

According to another aspect of the invention, the pair of opposed lugs and the further pair of opposed lugs can lie in a common plane.

According to another aspect of the invention, the pair of opposed lugs and the further pair of opposed lugs can extend from a common center.

According to another aspect of the invention, from the transport position, the mounting bracket can be rotated about the common center a predetermined angle for use.

According to another aspect of the invention, the pair of opposed lugs and the further pair of opposed lugs can be orientated 90° apart from one another, in the manner of a four-leaf clover, and the predetermined angle can be 90°.

The invention provides a convenient replacement for mounting brackets of the prior art which avoids the need for tape or the like to be used to secure the bracket to the window frame for transport and which can need to be laboriously removed.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1 is a plan view of a mounting bracket of the prior art;

FIG. 2 is a side view of the mounting bracket of FIG. 1;

FIG. 3 is a plan view of a mounting bracket according to an exemplary embodiment of the invention;

FIG. 4 is a side view of the bracket of FIG. 3;

FIG. 5 is a side view of a window extrusion according to the prior art;

FIG. 6 shows a mounting bracket according to FIG. 1 secured to a section of window frame extrusion in the manner in which mounting brackets of this type are secured to windows in use in the prior art;

FIG. 7 is a view similar to FIG. 6, but additionally showing a bracket according to FIG. 3 secured to the section of window frame extrusion in an orientation substantially similar to that of the bracket of FIG. 1;

FIG. 8 is a view similar to FIG. 7, but wherein the bracket according to the exemplary embodiment of the invention is rotated 90° relative to its position in FIG. 7; and

FIG. 9 is an end view of the structure of FIG. 6.

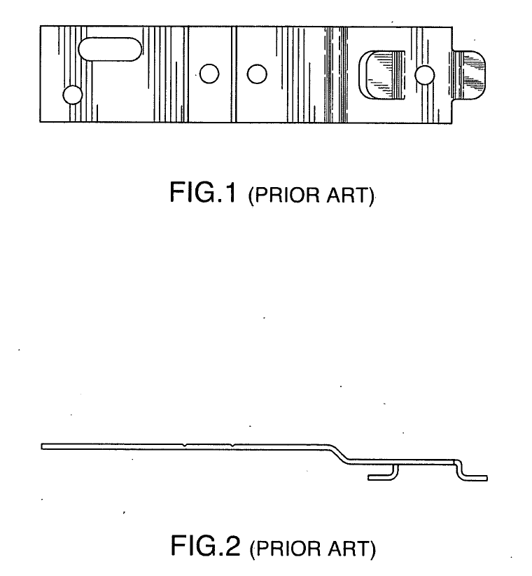

### DETAILED DESCRIPTION OF THE PREFERRED EMBODIMENT

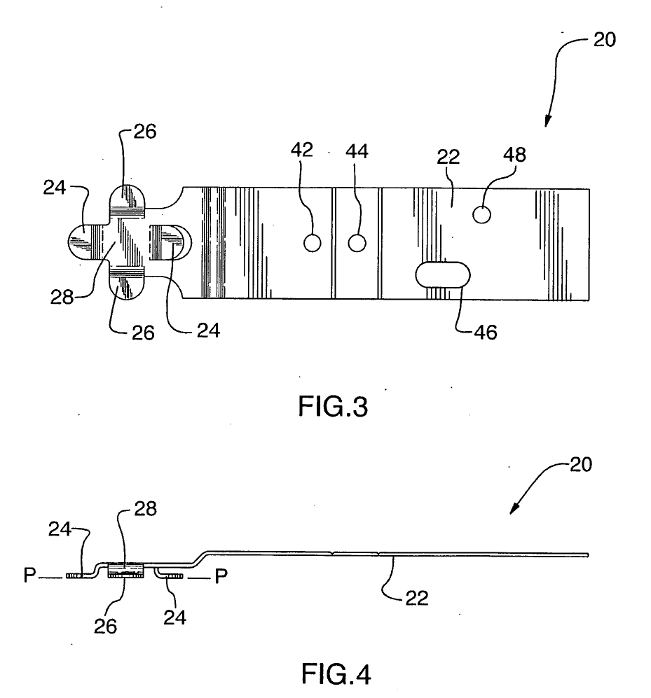

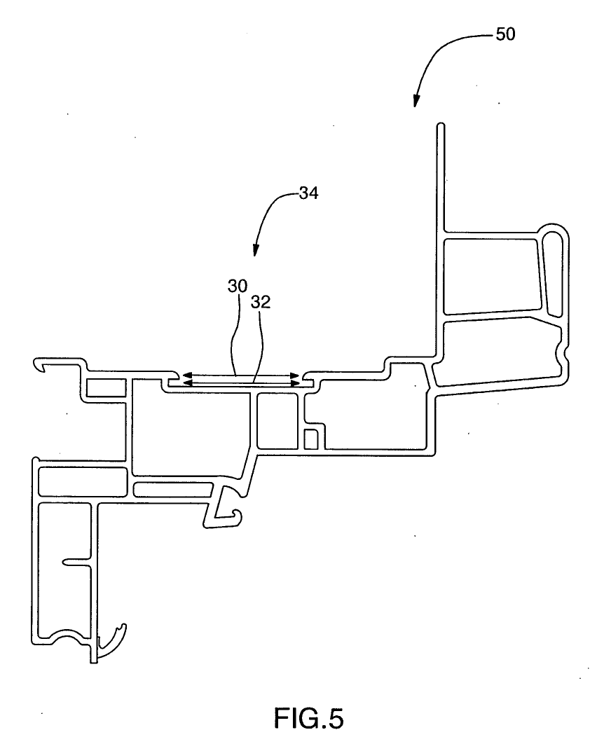

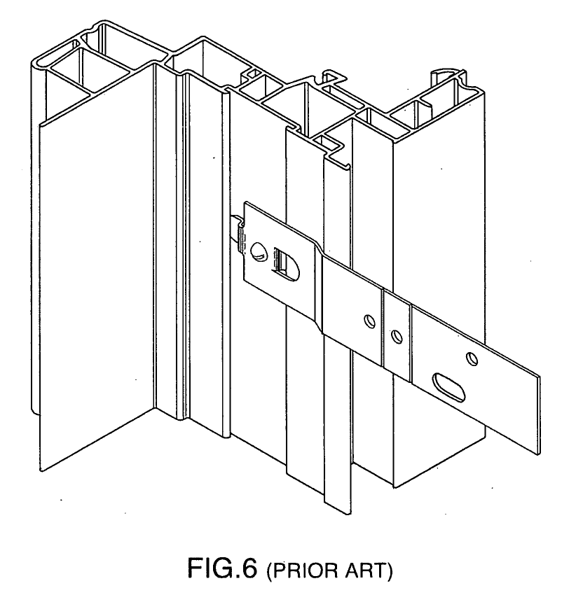

A mounting bracket 20 according to an exemplary embodiment of the invention is illustrated in FIGS. 3 and 4 and will be seen to comprise a bracket body 22, a pair of opposed lugs 24 rigidly connected to the bracket body 22 and a further pair of opposed lugs 26 rigidly connected to the bracket body 22. The pair of opposed lugs 24 and the further pair of opposed lugs lie 26 in a common plane P-P and extend from a common center 28, as shown in FIG. 4, and are orientated 90° apart from one another, in the manner of a four-leaf clover. The exemplary mounting bracket 20 illustrated is adapted to be stamped out of a single piece of 0.050″ galvanized steel and is provided with a plurality of apertures 42,44,46,48 for mounting the bracket body 22 to the frame of a structure adjacent a window opening (not shown) in a conventional manner.

The mounting bracket 20 is for use with a window frame (not shown) having a channel formed therein, the channel having a substantially T-shaped profile formed by a central slot defined in the window frame surface and a base disposed beneath the window frame surface to which the slot extends and which is bisected thereby. FIG. 5 is a sketch of a typical extrusion of the prior art, showing the channel 34, the slot 30 and the base 32 formed therein, this extrusion being of the type which is conventionally formed into window frames of the general type with which the invention is used.

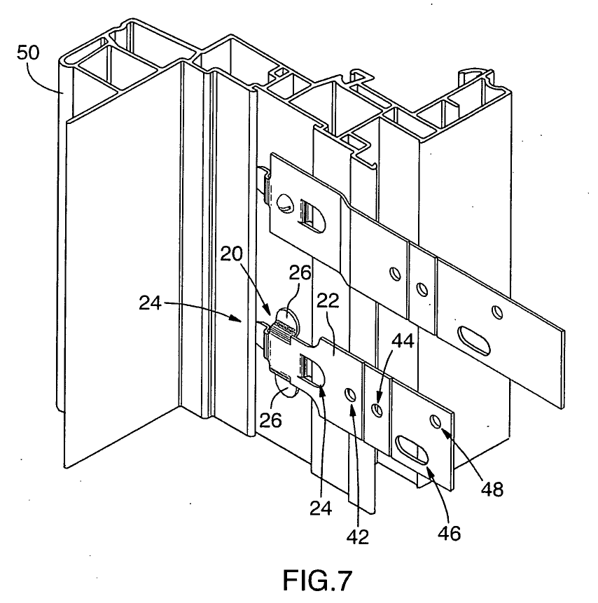

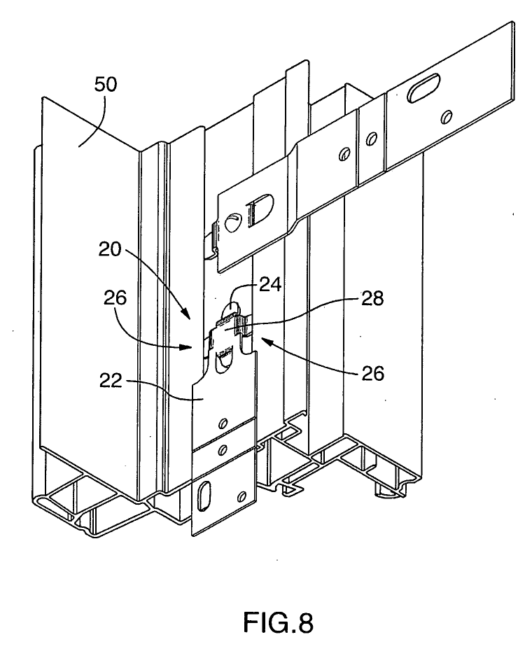

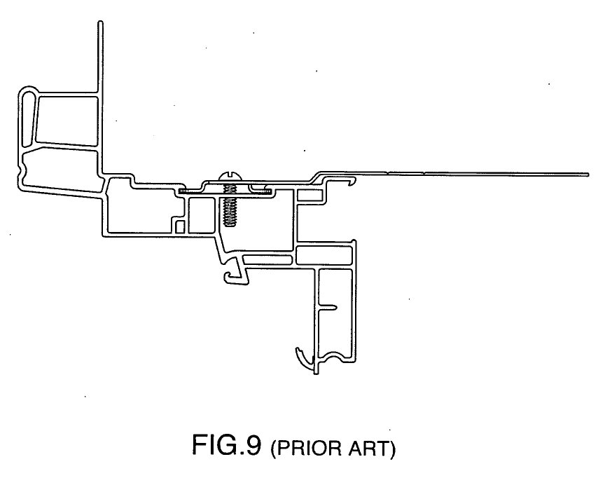

FIGS. 7 and 8 show a mounting bracket 20 according to FIG. 3 deployed with a section 50 of extrusion of the type illustrated in FIG. 5. FIG. 8 shows the mounting bracket 20 in a transport position wherein the further pair of opposed lugs 26 are rigidly, frictionally engaged in the base 32 and the bracket body 22 extends substantially lengthwise of the extrusion/frame 50.

From the transport position, the mounting bracket 20 can be rotated about the common center 28 a predetermined angle, in this case, 90°, to the operative position shown in FIG. 7, wherein the pair of opposed lugs 24 are rigidly, frictionally engaged in the base and whereat the bracket body 22 projects from the window frame to permit same to be fastened, in use, to the frame of a structure adjacent a window opening to secure said window frame in said window opening. Throughout such rotation, the lugs 24,26 remain in contact with the base of the channel, and at the operative position, the further pair of lugs 26 serve as “outriggers”, to stabilize the bracket 20.

In the embodiment illustrated, the stability provided by the cloverleaf arrangement avoids the need for a screw to be used to secure the bracket to the window frame in use. This has advantages in terms of the cost of the screw itself. As well, it is known for installers to utilize the wrong, i.e. oversize screws in installation, which can compromise the structural integrity of the profile and damage the seal. Further, even when screws of the correct size are used, drainage problems can result, since the protruding screw end can block or interfere with the drainage cavities formed in the window.

Whereas but a single exemplary embodiment of the mounting bracket is herein shown and described, it will be evident that various modifications can be made.

For example, whereas a cloverleaf arrangement is shown, similar utility could be obtained in arrangements wherein the further lugs were orientated at an angle less than 90°.

As well, more than four lugs could be employed, and the lugs need not lie in a common plane.

In view of these modifications, and others which may be apparent to persons of ordinary skill in the art, the invention should be understood as limited only by the claims appended hereto, purposively construed.

What is claimed is:

1. An improved mounting bracket
for use with a window frame having a channel formed therein, the channel having a substantially T-shaped profile formed by a central slot defined in the window frame surface and a base disposed beneath the window frame surface to which the slot extends and which is bisected thereby; and
of the type having: a bracket body which is fastened, in use, to the frame of a structure adjacent a window opening to secure said window frame in said window opening; and a pair of opposed lugs rigidly connected to the bracket body and which are frictionally engaged in the base in use,
wherein the improvement comprises:
a further pair of opposed lugs rigidly connected to the bracket body to provide a transport position for the improved mounting bracket wherein the further pair of opposed lugs are rigidly, frictional engaged in the base and the bracket body extends substantially lengthwise of the frame.

2. An improved mounting bracket according to claim 1, wherein the pair of opposed lugs and the further pair of opposed lugs lie in a common plane.

3. An improved mounting bracket according to claim 2, wherein the pair of opposed lugs and the further pair of opposed lugs extend from a common center.

4. An improved mounting bracket according to claim 3, wherein, from the transport position, the mounting bracket can be rotated about the common center a predetermined angle for use.

5. An improved mounting bracket according to claim 4, wherein the pair of opposed lugs and the further pair of opposed lugs are orientated 90° apart from one another, in the manner of a four-leaf clover, and the predetermined angle is 90°.

6. A mounting bracket for use with a window frame having a channel formed therein, the channel having a substantially T-shaped profile formed by a central slot defined in the frame surface and a base disposed beneath the frame surface to which the slot extends and which is bisected thereby, the mounting bracket comprising:
a bracket body;
a pair of opposed lugs rigidly connected to the bracket body; and
a further pair of opposed lugs rigidly connected to the bracket body the mounting bracket having:
a transport position wherein the further pair of opposed lugs are rigidly, frictional engaged in the base and the bracket body extends substantially lengthwise of the frame; and
an operative position wherein the pair of opposed lugs are rigidly, frictionally engaged in the base and the bracket body is fastened, in use, to the frame of a structure adjacent a window opening to secure said window frame in said window opening.

7. A mounting bracket according to claim 6, wherein the pair of opposed lugs and the further pair of opposed lugs lie in a common plane.

8. A mounting bracket according to claim 7, wherein the pair of opposed lugs and the further pair of opposed lugs extend from a common center.

9. A mounting bracket according to claim 8, wherein, from the transport position, the mounting bracket can be rotated about the common center a predetermined angle for use.

10. A mounting bracket according to claim 9, wherein the pair of opposed lugs and the further pair of opposed lugs are orientated 90° apart from one another, in the manner of a four-leaf clover, and the predetermined angle is 90°.
